(19) United States
(12) Patent Application Publication
(10) Pub. No.: US 2014/0201102 A1
(43) Pub. Date: Jul. 17, 2014

(54) METHODS AND SYSTEMS FOR AUTOMATIC FORM FILLING AND VALIDATION

(71) Applicant: XEROX CORPORATION, Norwalk, CT (US)

(72) Inventors: Raja Srinivasan, Chennai (IN); Nikesh Anand Rajagopalan, Chennai Tamil Nadu (IN); Vinoth KUMAR Arputharaj, Tirunelveli Tamilnadu (IN)

(73) Assignee: XEROX CORPORATION, Norwalk, CT (US)

(21) Appl. No.: 13/741,410

(22) Filed: Jan. 15, 2013

(51) Int. Cl. G06Q 10/00

(52) U.S. Cl. CPC G06Q 10/00
USPC 705/342

(57) ABSTRACT

The present disclosure discloses a method for filling-out one or more application forms. The method includes receiving an application form, the application form includes one or more fields. The method further includes identifying a type of the application form, and the fields. Further, the method includes detecting a mobile device in a location proximate to a device. Furthermore, the method includes receiving information from the mobile device in a pre-defined format. Moreover, the method includes matching the received information against the one or more fields of the application form. Additionally, the method includes overlaying the received information on the fields of the application form based on the matching.

### CROSS-REFERENCE TO RELATED APPLICATION(S)

The present disclosure is related to U.S. patent application Ser. Nos. 13/359,510, filed Jan. 27, 2012 (Attorney No. 20110532), and 13/559,630, filed Jul. 27, 2012 (Attorney No. 20120114), which are incorporated herein by reference in their entireties.

### TECHNICAL FIELD

The presently disclosed embodiments relate to application forms for various business services, and more particularly, to methods and systems for automatic form filling and validation.

### BACKGROUND

Business services, such as banking, telecom or insurance, play a significant role in the day-to-day life of many individuals. Subscribers often need to complete or otherwise fill-out one or more application forms if subscribing to any of the above or other business services. These forms may also vary based on the service at hand. For example, a customer seeking to open a new account with a bank may complete an account opening form, while a customer seeking to apply for a loan may complete a corresponding loan application form. In some current or related art banking scenarios, a customer may fill-out or otherwise complete an application form or forms in the presence of a bank branch representative. The bank branch representative may then manually check the application form(s) to verify whether they are completely filled-out or not. The representative may also check the forms to ensure that they are correctly filled-out. The application form is then couriered to a bank back-office for further checking and processing. The forms are validated again at the back office. This process continues until the application form(s) are completed appropriately and any other appropriate documents are submitted.

Customers often fill-out or otherwise complete forms by hand or using known or related art systems that are completely or partially manual. In one example that involves a customer filling-out multiple forms, for e.g., for opening a bank account, the customer may provide a variety of information, such as name, date of birth, address, contact number, etc., that may need to be repeated across multiple forms. Since the customer typically needs to complete or otherwise fill-out these forms one-by-one manually, filling-out or adding the same information separately to different forms is inefficient. This existing or related art approach is time-consuming for the customer, involves some or even a significant manual effort, and increases the processing time. Thus, methods and systems for automatic form filling and validation may be beneficial.

### SUMMARY

The present disclosure discloses a method for filling-out one or more application forms. The method includes receiving an application form, the application form includes one or more fields. The method further includes identifying a type of the application form, and the fields. Further, the method includes detecting a mobile device in a location proximate to a device. Furthermore, the method includes receiving information from the mobile device in a pre-defined format. Moreover, the method includes matching the received information against the one or more fields of the application form. Additionally, the method includes overlaying the received information on the fields of the application form based on the matching.

The present disclosure discloses a system for adding information to application forms. The system includes a unit configured to receive an unfilled application form, the unfilled application form includes various fields. The system further includes a processor configured to identify a type of the application form, the fields, and other related information of the application form. The processor is further configured to detect a mobile device located within a predetermined range of the system. Furthermore, the processor is configured to receive information from the mobile device in a pre-defined format. Moreover, the processor is configured to match the received information against the fields included in the unfilled application form. Additionally, the processor is configured to overlay the received information on the unfilled form, based on the matching performed.

Further, the disclosure discloses a method for automatically filling-out one or more application forms. The method includes receiving an application form, the form includes a plurality of fields. Once the form is received, information related to the application form is identified. Then, a form filling application is initiated on a first device including a processor. After this, a second device including a storage medium, in an area proximate the first device is detected. Thereafter, information from the second device in a pre-defined format is received. As a next step, one or more fields of the plurality of fields in the application form, corresponding to the received information is identified. Then, at least one of completeness and correctness of the received information is checked. The received information is then placed at corresponding coordinates of the identified fields. Finally, a filled out application form is outputted.

Moreover, the disclosure discloses an automation system interacting with a mobile device, for automatically filling-out application forms. The automation system includes a unit configured to receive an unfilled application form. The form includes various fields. The system includes a processing module configured to identify information related to the unfilled application form. The processing module is further configured to initiate a form filling application on the automation system. The processing module is configured to detect a mobile device in a location proximate to the automation system. Also, the processing module is configured to receive user information from the mobile device. Furthermore, the processing module is configured to identify one or more fields corresponding to the received user information. Additionally, the processing module is configured to check for at least one of completeness or correctness of the received information. The processing module is configured to overlay the received user information on the identified fields and output a completed application form.

Additional embodiments disclose a method. The method includes receiving an input from a user. The method further includes identifying an application form, based on the input, the application form includes various fields. The method includes initiating a form filling application on a first device. The method includes detecting a second device, in an area proximate the first device. Further, the method includes receiving information from the second device in a pre-defined format. Also, the method includes identifying one or more fields corresponding to the received information. The method includes checking for at least one of completeness and correctness of the received information. Moreover, the method includes generating an image of the received information. The method includes placing the image at corresponding coordinates of the identified fields and then finally a filled out application form is outputted.

### BRIEF DESCRIPTION OF THE DRAWINGS

FIG. 1 illustrates an exemplary overall system in which various embodiments of the disclosure can be practiced.

FIG. 2 is a flowchart of a method for automatically filling-out and validating application forms, according to an embodiment of the disclosure.

FIG. 3A illustrates an exemplary screenshot of user information stored in a mobile device.

FIG. 3B shows an exemplary file, transferred from the mobile device to an automation system.

FIG. 3C is an exemplary screenshot displaying a completed application form on the mobile device.

FIG. 4 is a block diagram illustrating interaction among various components for automatic form filling and validation, according to an exemplary embodiment.

FIGS. 5A-5G are exemplary snapshots illustrating a sequence for transferring information from the mobile device to a multi-function device.

### DETAILED DESCRIPTION

The following detailed description is provided with reference to the figures. Exemplary, and in some case preferred, embodiments are described to illustrate the disclosure, not to limit its scope, which is defined by the claims. Those of ordinary skill in the art will recognize a number of equivalent variations in the description that follows.

### Definitions

Definitions of one or more terms that will be used in this disclosure are described below. The disclosure includes a device that generally facilitates the automation of various types of operations that are performed in a business center, such as a bank branch, telecom center, postal office, or the like.

In the context of the present disclosure, the “device” automates the process of form filling and validation. For ease of reference, this device will be referred to as an “automation system” since it serves to automate the process of filling-out forms, validating those forms and other related activities. The “automation system” can be capable of receiving an input, and may include a display unit for displaying an output. Additionally, the “automation system” may be configured to perform one or more operations, including printing, scanning, faxing, and copying.

As used herein, a “Multi-Function Device” (MFD) is a single device that offers a number of traditionally separate functionalities, such as printing, copying, scanning, and/or faxing, for example. In the context of the disclosure, the “MFD” is configured to automate the process of form filling and validating the forms. The “mobile device” refers to any computing device capable of sending or receiving data to or from other computing devices, including, but not limited to, an automation system, a multi-function device, or other equivalent device. The “mobile device” is also capable of processing and displaying information.

The “automation system” can participate in a network with a number of other devices and entities. For purposes of this application, a “headquarter device” refers to a device at a higher organizational level than the automation system, while a “peer device” refers to a device at the same general organizational level as the automation system. “Support systems” or “back-office systems” refer to systems that perform support and/or services, such as data entry, verifying documents, or processing transactions, or the like.

### Overview

The disclosure generally relates to handling application forms corresponding to various business services, including but not limited to, banking, telecom, or postal services. Different application forms may be applicable to each of these business services. For example, banking services may have forms relating to opening a new account, changing personal information, or applying for a loan, whereas forms for telecom services may include buying a new connection, etc.

A number of fields, such as fields for information relating to name, age, gender, date of birth, address etc., are generally present in all of these forms. Thus, the user fills-out or otherwise completes these fields repeatedly at the time of filling-out the various forms. Filling-out the same information manually is an inefficient use of human energy, effort, and/or time. Additionally, this procedure may frustrate the user. To address or even overcome the above challenges, some of the disclosed embodiments provide methods and apparatuses for automatically filling-out application forms, such as by using an automation system. The automation system interacts with a mobile device for automatically filling-out application forms. An application running on the automation system detects a mobile device in a location proximate the automation system. The automation system requests the device to share information, such as information including name, age, email, contact details etc. The automation system then receives the information and places that information over an unfilled application form. Finally, the automation system outputs a completed application form.

### Exemplary Embodiment

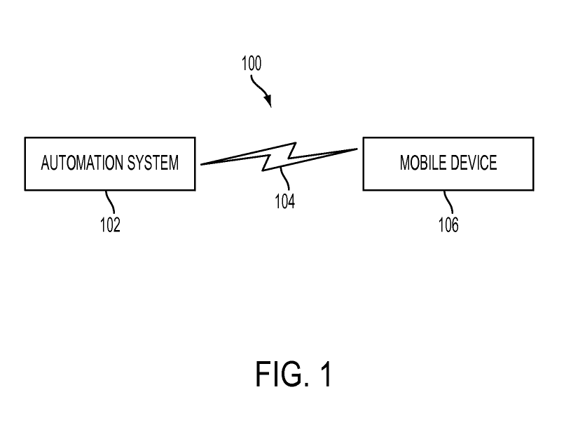

FIG. 1 illustrates an overall exemplary system 100. The system 100 includes an automation system 102, which can be a Multi-Function device, and a mobile device 106. Various examples of the mobile device 106 include, but are not limited to, smart phones, Personal Digital Assistant (PDA), tablets, or the like. The automation system 102 and mobile device 106 communicate with each other via wireless link 104. However, other embodiments can use other related art or later developed methods and apparatus to enable communication between the automation system 102 and mobile device 106.

The automation system 102 can perform a number of operations that are performed in a business center, bank branch, or other business or organization. For example, the system 102 may perform form related functions, such as scanning, printing and copying. In the context of the present disclosure, the automation system 102 automatically fills-out, complete, or otherwise add information to application forms, such as a form for opening a bank account, a form to apply for a loan, etc. Further, the automation system 102 checks for correctness and/or completeness of the filled-out forms. The automation system 102 can communicate with the mobile device 106 through various communications modes, including wirelessly. Various examples through which these systems can communicate include, but are not limited to, Near Field Communication (NFC), Bluetooth, Short Message Service (SMS), and Multi-media Messaging Service (MMS), etc.

Initially, the automation system 102 receives an unfilled form. The unfilled form includes various fields, such as name, age, date of birth, permanent address, communication address, PAN card, and other information. The fields may vary with the form type. Then, the automation system 102 identifies the form and requests that the mobile device 106 transfer information related to the various fields. Thereafter, the mobile device 106 transfers the requested information to the automation system 102. The automation system 102 then places the received information over the unfilled form, resulting in a more complete or completely filled-out application form.

### Exemplary Flowchart

Many users often carry or otherwise possess mobile devices, e.g., smart phones, and these smart phones have personal information, and in some cases a substantial amount of personal information stored therein. Personal information includes name, contact, email ID, address, PAN card information, or other relevant or similar information. Such information corresponds to various fields of the application forms. Therefore, the present disclosure focuses on utilizing the readily available personal information in these phones for filling-out various application forms. In other words, instead of writing the application forms, information available within the phones is transferred from the phones to an automation system or an equivalent or similar system. The automation system then automatically fills-out the application forms.

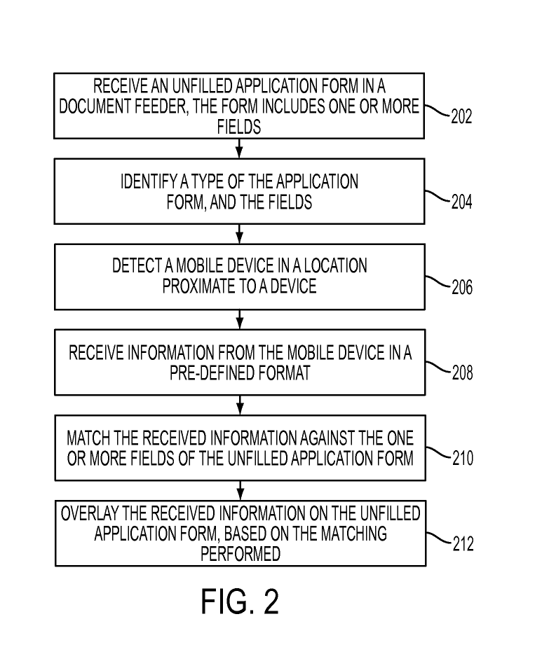

FIG. 2 is a flowchart of a method for automatically filling-out application forms, such as by using the automation system 102 for filling-out forms on the behalf of a user. The automation system 102 interacts with the mobile device 106 for filling-out these forms and for other relevant or related purposes.

The automation system 102 is pre-configured with information about each field for each form. For example, the automation system 102 can be aware of some or all types of forms, related fields, and corresponding positions/coordinates, or the like. This information can be pre-fed or input to the automation system 102 either by OCR (Optical Character Recognition) the form details, or by using different systems at the back end. In some embodiments, the user can input some or all the details in the automation system 102. The automation system 102 can also include templates for each form.

In one exemplary embodiment, the automation system 102 captures various parameters related to every form, such as “field name”, “field input space type”, “starting X”, “starting Y”, “height”, “width”, “ending X”, “ending Y”, “number”, “type”, “ErrMsg”, and “threshold”. The parameter “field” captures the name of the fields, such as first name, age, or the like. The parameter “field input space type ” defines whether the input type is a line, box, or open space. “Starting X” is the X coordinate of the starting position from where the input needs to be overlaid or printed, whereas “starting Y” is the Y coordinate of the starting position from where the input needs to be overlaid or printed. “Height” denotes the height of the respective field, in a completely or partially unfilled-out form, and “width” being the width of the respective field in the unfilled-form. “Ending X” is the ending X position until the input can be overlaid and/or printed. “Ending Y” is the ending Y position until the input can be overlaid and/or printed. “Number” denotes the number of boxes (where characters can be entered) in case the input field is a box. “Type” denotes the data type (String/Number/etc) of the respective field. For example, the field “full name” is a string type, while the field “phone number” is a number data type. Moreover, the field “address” may be alphanumeric. “Errmsg” refers to an error message to be displayed if an incorrect or incomplete entry is input in any field in the form. The error message may be prompted if any validation error is captured while processing the received information or filled-out application form. Additionally, the “threshold” is the average pixel intensity for a particular field, and is used as one of the criteria to determine whether all of the information has been entered, i.e., whether the form is completely filled-out or not. The “threshold” values may range from 0 to 255; the value 0 representing all black pixels fields, while 255 indicates all white pixel fields. Alternatively, the value 0 may denote all white pixels, and 255 may represent all black pixels. For example, the threshold 245 means that at least 4% of the box must have black pixels for the field to be considered filled. If the number is higher than 245, then the number of white pixels exceeds the threshold, and the field is considered not to be filled-out.

At step 202, the method starts with receiving an input, i.e., an unfilled application form, from a user in a document feeder unit. The form includes various fields, such as name, age, address, email, contact, PAN card, or the like. Based on the input, at step 204, a type of the application form, and the fields are identified. In some embodiments, other related information about the application form, but not limited to, coordinates of each field, or background information is also identified. In some embodiments, the user inputs—the type of application form through the automation system 102.

In some embodiments, the method includes checking whether the form type provided by the user matches the form placed in the document feeder unit. If the form type does not match the form placed, the method includes prompting the user to place the correct form in the document feeder unit.

Thereafter, a form filling application is automatically initiated on the automation system 102, but in some instances, the form filling application is initiated by the user.

At step 206, a mobile device in a location proximate to a device, such as automation system 102 is detected. Once detected, a communication channel between the automation system 102 and the mobile device 106 is established. Thereafter, information exchange application is activated on the mobile device 106, and then the mobile device 106 starts sending user/personal information stored in the mobile device 106, such as a storage module/medium. The personal information corresponds to one or more fields of the application form as input in the document feeder unit. Examples of the personal information include, but are not limited to, name, date of birth, address, contact number, email address, PAN card, or other information.

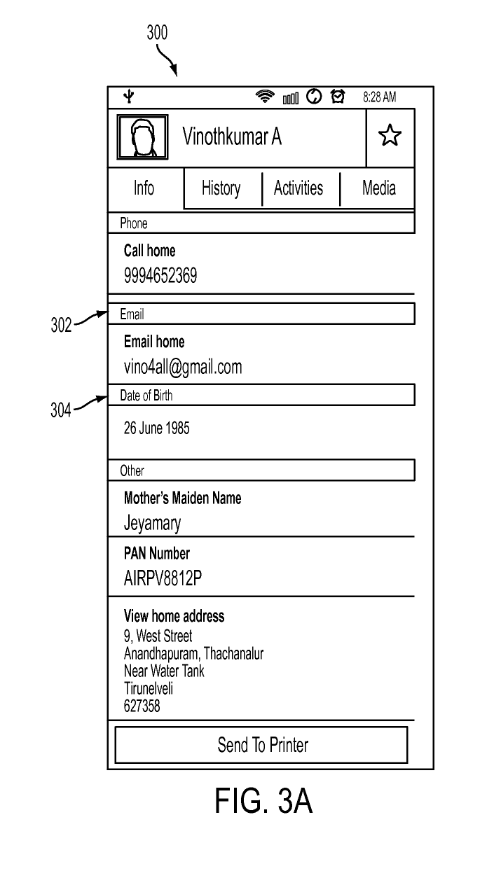

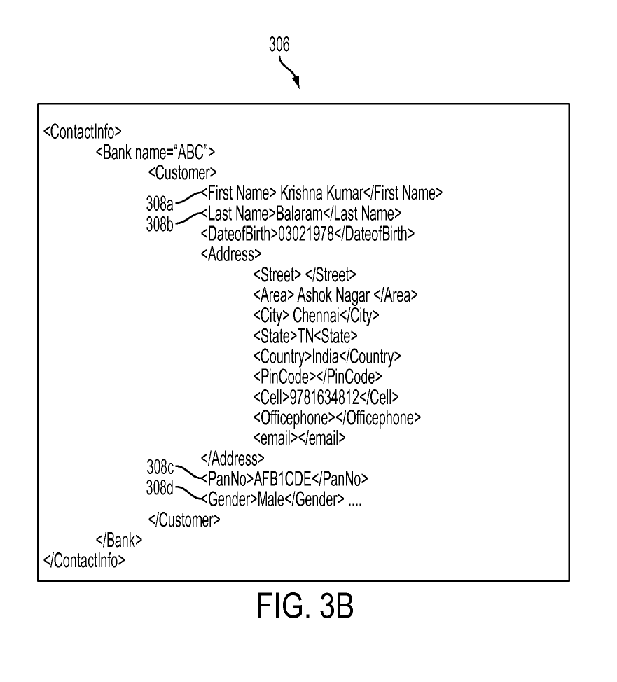

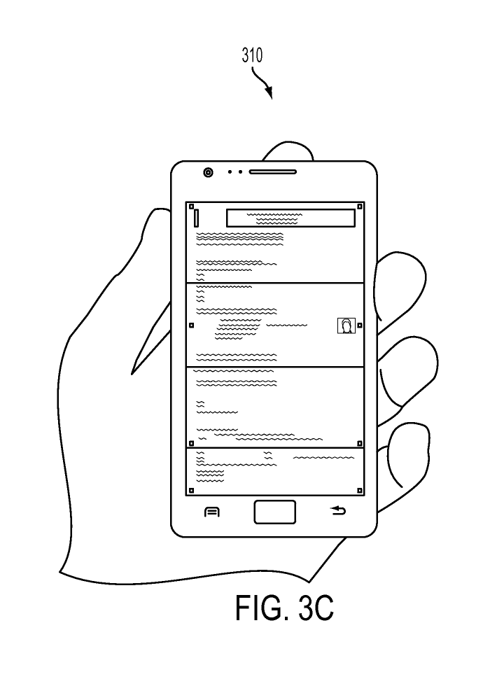

FIG. 3A shows an illustrative mobile device 300 having personal information stored therein, such as an email address 302, date of birth 304, and so on.

The personal information is sent from the mobile device 106 to the automation system 102 in a pre-defined format, such as XML.

FIG. 3B shows one exemplary XML file 306 that includes personal information, such as first name 308a, last name 308b, PAN 308c, gender 308d, or the like. This exemplary file 306 is transferred from the mobile device 106 to the automation system 102.

In an embodiment, the mobile device 106 sends the personal information, such as by sending the information one at a time, to the automation system 102. For example, contact information is sent first, then the email address, and so on. However, in other embodiments, the mobile device 106 transfers the entire personal information in one transmission, as opposed to sending the information one at a time.

In certain embodiments, the mobile device 106 converts the information from the XML format to a second format, wherein the second format is one that is understandable by the automation system 102. In one example, the second format can be, but not limited to, plain text format.

In cases, where some information is not available in the mobile device 106, the information can be collected from various sources and grouped into the mobile device 106.

Next, in step 208, the personal information is received by the automation system 102 from the mobile device 106. The received information is parsed, and then matched with the fields included in the unfilled application form at step 210. For example, name information is matched with the field “full name” of the application form. The date of birth information is matched with the field “age” in the form. After matching, the automation system 102 checks for fields that do not have matching information in the received personal information. The method includes the step of creating a list of fields that are unfilled or not completed.

Examples of such fields may include nominee name, account type, names of references, office landline number, landmark near address, mother's maiden name, or others. Consequently, the automation system 102 requests that the user provide inputs on those fields. In one embodiment, the user can fill-out such remaining fields on the automation system 102 itself. While in other embodiments, the automation system 102 shares its user interface with the mobile device 106, and requests the user to provide required or requested information therein. To this end, the mobile device 106 uses an application that allows the mobile device 106 to view the user interface (screen) of the automation system 102. The application enables the user to view the information, such as the form that is displayed on the automation system 102. One such exemplary screen is shown in FIG. 3C, the user interface 310 of the automation system 102 is displayed. The user may enter the information through the mobile device 106, and information is transferred to the automation system 102 for validation. The application can be any known, related art, or later developed user interface (UI) application, and thus structural and functional details do not need to be described.

Additionally, the automation system 102 checks for correctness of the received information.

Then, at step 212, the information is appropriately overlaid on the corresponding fields in the form. For example, the name information is filled-out against the field “Full Name” in the application form. In particular, the automation system 102 overlays the matched information in the appropriate coordinate or position of that field in the application form. Alternatively, the received information is appropriately printed at respective coordinates of the fields in the form. Overlaying can be performed in scenarios, where the received information includes text data and/or image data, whereas printing can be performed when the received information includes text data.

In some embodiments, the method performs the step of generating an image of the received information and that received image is placed at corresponding coordinates of the identified fields. In particular, the image is generated with no background information.

Finally, a completed application form is outputted.

Once the form is completely filled-out, the completed form is sent to a back-office for further processing. In other embodiments, the completed form can be printed out automatically. As a next step, the user can collect the completed form and submit it to a bank or branch representative.

As discussed above, the mobile device 106 transfers the information to the automation system 102 through a near field communication. However, in other embodiments, the information can be also be transferred through other modes, such as Bluetooth, RFID, SMS, or MMS. For the scenario SMS or MMS, the automation system 102 includes a cellular interface. All of the structural and functional details related to the cellular interface are described in U.S. patent application Ser. No. 13/329,352, entitled “Remote Management for Multi-Function Devices,” which is expressly incorporated herein by reference.

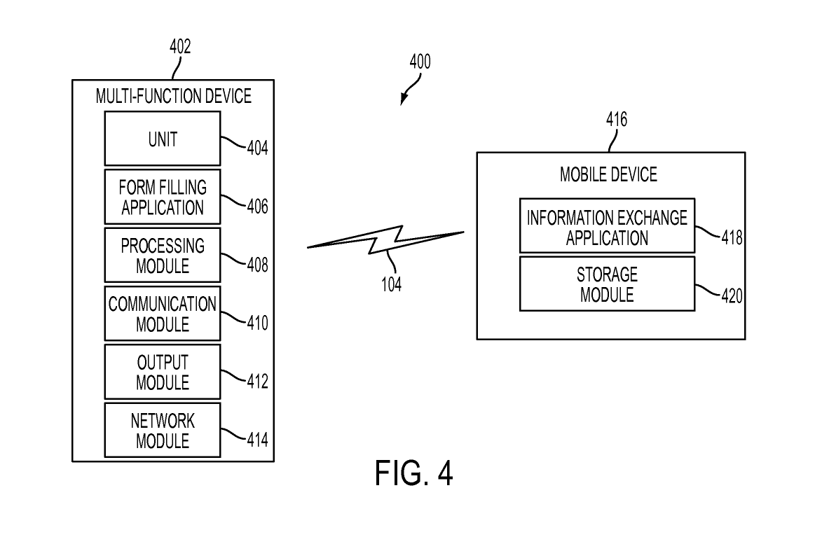

FIG. 4 illustrates a system 400 for automatically filing-out application forms, according to one embodiment of the disclosure. More particularly, the system of FIG. 4 includes a multi-function device 402 and a mobile device 416. The multi-function device 402 includes a unit 404, form filling application 406, processing module 408 (or processor), communication module 410, output module 412, and network module 414. Additionally, the multi-function device 402 includes a user interface and an input module (although not shown).

As shown, the mobile device 416 includes a storage module 420, and an information exchange application 418.

### Multi-Function Device

Unit 404, such as a document feeder in this embodiment, is adapted to receive one or more unfilled application forms. The application forms can be partially filled-out forms, where some the fields are pre-filled by a user. Alternatively, the application forms can include completely unfilled forms, where none of the fields are already filled-out. The forms placed in the unit 404 can be related to opening a new account, applying for a loan, or the like, or a combination thereof. For simplicity, unit 404 can be considered to include an unfilled application form for opening a bank account. However, for a person skilled in the art, it is clear that there may be any number of forms in the unit 404 and may relate to various business or other types of services.

Processing module 408 identifies the form placed in the unit 404. In particular, the processing module 408 identifies a type of form, various fields, and other information related to the application form. Processing module 408 identifies whether the form related to savings, term deposit accounts, salary savings accounts, or other relevant type. The step of identification of fields includes identifying all of the fields that are present in the application form. Further, the processing module 408 identifies the position or coordinates of each field in the forms. The processing module 408 further determines whether the fields are optional or mandatory, and determines the number of characters, data type for each field, etc. It also identifies the type of fields to be filled-out, i.e., whether it is a line or a box. For each applicable field, any dependent fields are also identified. For instance, the field “nominee name” is dependent on the field “nomination checkbox”. If Nomination checkbox is checked (ticked), then nominee name needs to be provided. In another example, if the user fills-out the details for the field “second applicant”, then mother's maiden name needs to be filled-out.

Subsequently, the processing module 408 initiates the form filling application 406 on the multi-function device 402, and detects a mobile device, such as mobile device 416, in a nearby area.

After detection, the processing module 408 interacts with a communication module 410 for establishing a channel between the multi-function device 402 and the mobile device 416. Once the channel is established, the mobile device 416 starts sending information. The information is the personal information about the user, which can correspond to one or more fields usually present in any application form. The personal information includes, but is not limited to, name, age, address, email, contact, PAN card, or the like.

The processing module 408 then receives the information from the mobile device 416. Thereafter, the processing module 408 matches the received information with the one or more fields in the application form. For example, if the received information includes “name”, then this information is matched against the field “full name”. In another example, if the received information is “age”, then the “age” is matched against the field “date of birth” in the application form. Some or all of the received information can be similarly matched. Then, the processing module 408 checks whether any of the fields in the form remain unfilled. If so, then the processing module 408 interacts with the mobile device 416, and requests the user to input the remaining information, such as nominee name, or the like. The user provides this information either via the mobile device 416 or through the MFD 402. In the first case, the MFD 402 shares its screen with the mobile device 416, and allows the user to input the required or requested data. In the second case, the user can provide the required or requested information on the MFD 402 itself.

Additionally, the processing module 408 checks whether the received information is correct or not. For example, if the field phone includes a 9 digit entry, then the processing module 408 displays an error and requests the user to correctly fill-out that entry.

Once the processing module 408 validates the form, the processing module 408 performs, but not limited to, overlaying the received information in respective coordinates in the received application form. Before overlaying the information on the form, the processing module 408 checks whether the form placed in the unit 404 is correct or not. To this end, the processing module 408 scans and verifies whether the loaded form is correct. The processing module 408 matches the form against the existing template. Based on the matching, if it is found that the form is incorrect, then the MFD 402 prompts the user to place the correct form in the unit 404. In some embodiments, the MFD 402 includes a scanning module for scanning the form.

In certain embodiments, the processing module 408 overlays the received information on the template (already pre-fed or pre-stored in the MFD 402) corresponding to the identified form as discussed above.

Finally, an output module 412 outputs the completed application form. In some embodiments, the output module 412 can provide various types of outputs to the user, including a document, display, etc.

Network module 414 is configured to send the completed form to the back-office for further processing, such as data entry, further verification, etc. In general, the network module 414 connects the MFD 402 to headquarters systems, support systems or peer systems. The support systems or the peer systems form a part of back-offices, including a stationery office, a processing center for verifying the one or more filled-out forms and documents, an office for data entry, an office for courier or shipping of documents, third party validation systems, or a center for any other manual work.

A user interface is configured to display information related to the application form. For example, the user interface displays the fields, which are not correctly filled-out or are wrongly filled-out. In another example, the user interface is configured to display the completed application form. Additionally, the MFD 402 includes an input interface that is configured to receive an input provided by the user. In one embodiment, the input may be provided using input devices, such as a keyboard, mouse, display, user interface, touch pad, and the like.

Additionally, the MFD 402 includes a database (not shown) configured to store form templates, and other form related information.

The multi-function device 402 disclosed above can be a single unit that performs one or more functionalities described above. However, the multi-function device 402 can instead be one or more units each performing one or more of the functionalities of printing, scanning, copying, and faxing, for example. In other embodiments, the multi-function device 402 can be replaced with a printer, a scanner, and/or a copier. For various other embodiments, the multi-function device 402 may be a standalone printer, facsimile machine, or other device.

### Mobile Device

The mobile device 416 can include mobile phones, smart phones, Personal Digital Assistants (PDAs), Pagers, Enterprise Digital Assistants (EDAs), iPhones, iPads, or the like.

As mentioned above, an information exchange application 418 runs on the mobile device 416, and the application 418 is configured to transfer the information from the mobile device 416 to the multi-function device 402. This transfer can be accomplished in accordance with any known, related art, or later developed method or system, for example, mobile device 416 can transfer the information to the MFD 402 wirelessly. Various examples of wireless communication include, but are not limited to, Near Field Communication (NFC), Bluetooth, Short Message Service (SMS), Multimedia Messaging Service (MMS), Wi-Fi and so forth.

NFC operates via the principle of magnetic induction. If two NFC-enabled devices contact each other, then the devices automatically recognize each other and are activated. Consequently, the devices start sending or receiving information to or from each other. In detail, an initiator, i.e., the MFD 402 in this embodiment, uses magnetic induction to create a radio-wave field that a target, i.e., the mobile device 416, detects and accesses, allowing data to be transferred wirelessly over a pre-defined distance. In other embodiments, the mobile device 416 transfers the information to the MFD 402 via SMS, MMS, or any other known related art or later developed method of system. To this end, MFD 402 incorporates cellular interface functionality. This means that the MFD 402 includes cellular information in terms of sim card and phone number, and is capable of receiving the information from the mobile device in a manner that is similar to sending SMS messages or MMS between mobile devices. The cellular interface may include any known, related art or later developed cellular technology, such as global system of mobile communication (GSM), code division multiple access (CDMA), wideband CDMA (WCDMA), Time Division Synchronous CDMA (TD-SCDMA), etc. Any known or later developed telecommunication technology may be utilized to provide cellular connectivity. In the case of GSM technology, the cellular card may be a Subscriber Identity module (SIM card). A GSM-enabled scanning device may communicate with devices in a remote location, such as a cell phone, using voice or SMS services.

The storage module 420 is configured to store personal information about the user in a pre-defined format. The pre-defined format can be, but is not limited to, XML. In other embodiments, the information may be stored in a user understandable format. In some embodiments, the personal information can be updated for later usage.

The mobile device 416 also includes a processing module (although not shown) configured to determine the format for sending the information to the MFD 402. The processing module can be further configured to decide how the information needs to be sent to the MFD 402—sending the information one at a time or sending all the information in one go, as discussed above.

In certain embodiments, the mobile device 416 includes an application configured to view the details displayed on the MFD 402.

In many embodiments, the mobile device can include an image capturing unit, such as camera, a user interface, and a transceiver unit. The image capturing unit is used for capturing/scanning an image of application form, for example. The user interface can be a display screen for displaying information such as filled-out application forms and the like. The transceiver unit is used for sending or receiving the information. Additionally, the mobile device may include other necessary components required for implementing the method disclosed in the present disclosure.

Additionally, the components/modules of the MFD 402, and mobile device 416 respectively, are connected internally via a known, related art or later developed communication bus. The aforesaid components perform their respective functions, and further interact with each other, thereby, enabling the system to function appropriately.

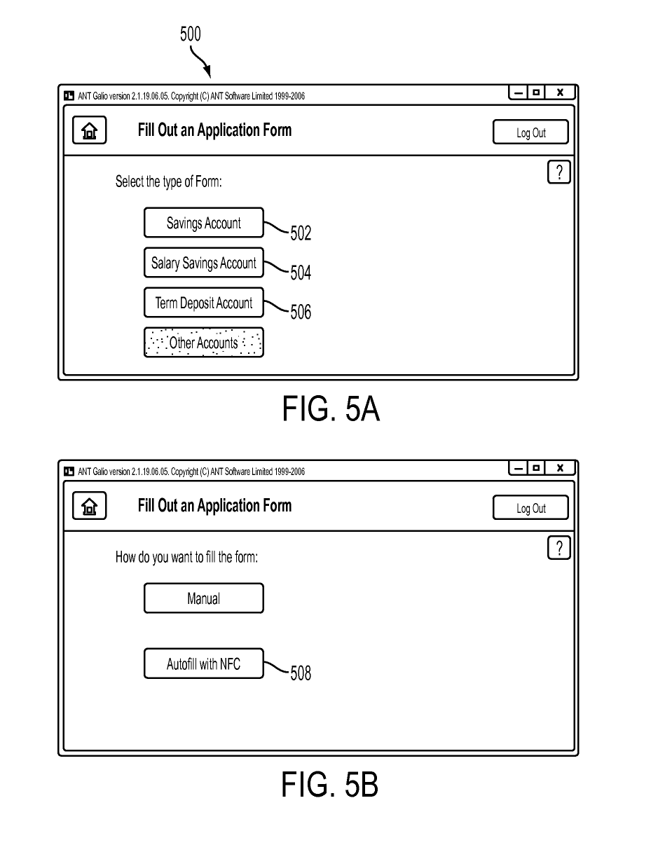

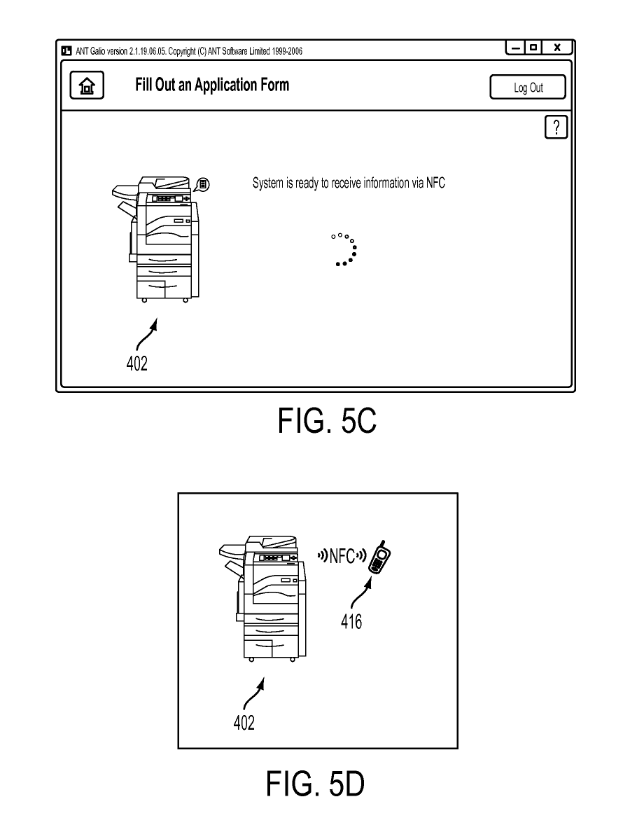

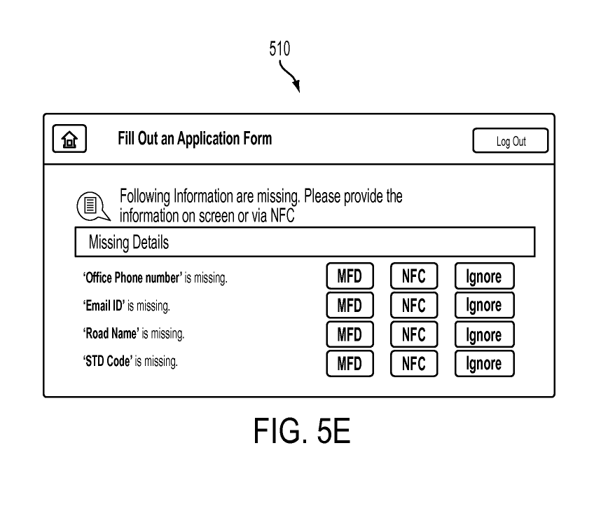

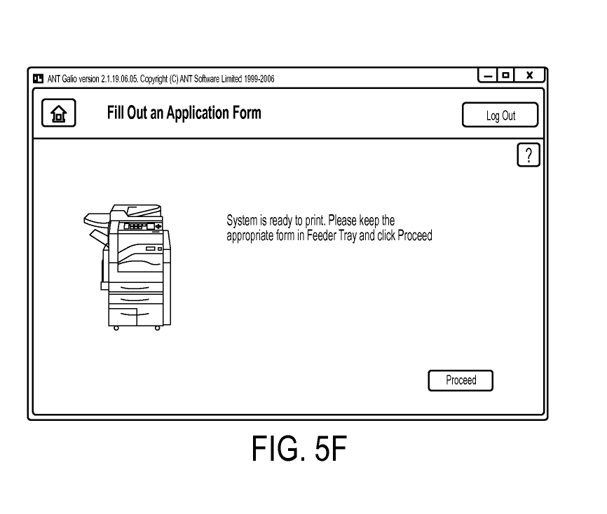

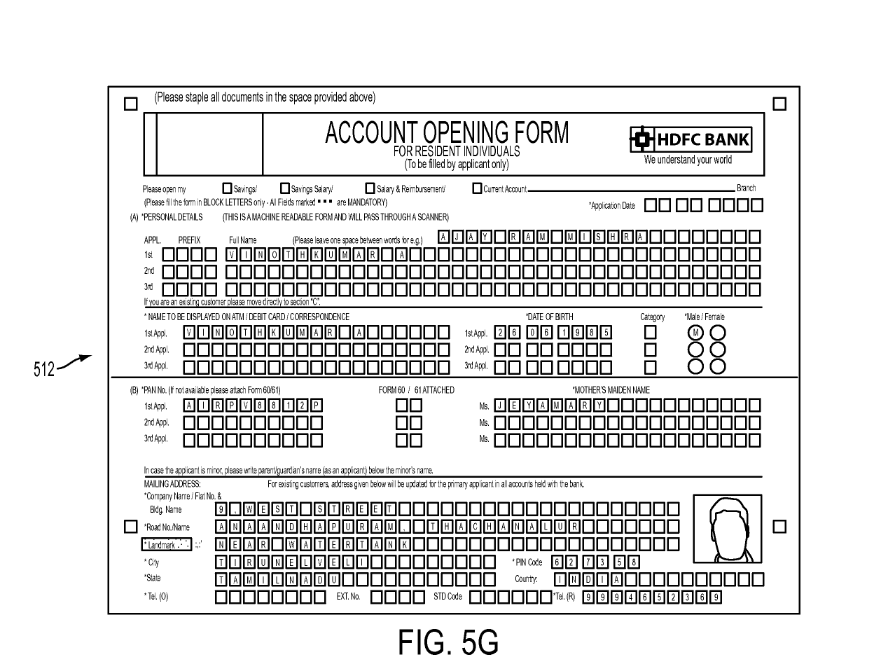

FIGS. 5A-5G are exemplary snapshots illustrating a sequence for transferring information from the mobile device 416 to the multi-function device 402, such as to automatically fill-out or validate a form, according to one exemplary embodiment.

The user interface 500 of the multi-function device 402 displays one or more options to the user. Various examples of the options include: savings account 502, salary savings account 504, or term deposit account 506, as shown in FIG. 5A. Here the user selects one of the displayed options, for example, savings accounts 502. After this, two options are displayed to the user, as shown in FIG. 5B. In the context of the current disclosure, it is considered that the user selects the option auto fill with NFC, marked as 508. Thereafter, an auto form filling application is initiated on the multi-function device 402 and this device detects the NFC enabled mobile device shown in FIG. 5C. As shown in FIG. 5D, the multi-function device 402 receives the information from the mobile device 416 via NFC. After receiving the information, the multi-function device 402 checks for any missing fields and/or correctness of the information. Accordingly, the missing fields are displayed to the user through a dialog box 510, as shown in FIG. 5E. Then, the multi-function device 402 is ready to overlay or print the received information on the unfilled form, and the device 402 prompts the user to place the appropriate form in the feeder, as shown in FIG. 5F. Consequently, a completed or filled-out form 512 is outputted, as shown in FIG. 5G.

The present disclosure discloses methods and systems for automatically filling-out forms, thereby partially or completely obviating manually writing the forms. The methods and systems are capable of dealing with completely unfilled forms as well as partially unfilled forms. The disclosure also focuses on automatically checking completeness and/or correctness of forms, thereby reducing processing time. Since the form does not include hand written entries, or the hand written entities are reduced, validation process becomes easy and/or faster. Also, the disclosed methods and systems enhance the user's experience in filling-out forms. Moreover, no Internet connection is required for transferring the information from one device to another. Additionally, the disclosed methods and systems speed-up the overall process, and/or speed-up on-boarding the customer.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for automatically filling-out one or more application forms, comprising:
receiving an application form, the application form includes one or more fields;
identifying a type of the application form, and the fields;
detecting a mobile device in a location proximate to a device;
receiving information from the mobile device in a pre-defined format;
matching the received information against the one or more fields of the application form; and
overlaying the received information on the fields of the application form, based on the matching.

2. The method of claim 1, further comprising activating an application on the mobile device.

3. The method of claim 2, wherein the application activated on the mobile device is an information exchange application.

4. The method of claim 1, wherein the device includes at least one of: a multi-function device, a scanning device, and a printing device.

5. The method of claim 1, further comprising activating an application on the device.

6. The method of claim 5, wherein the application activated on the device is a form filling application.

7. The method of claim 1, further comprising checking at least one of completeness and correctness of the received information.

8. The method of claim 1, further comprising parsing the information received from the mobile device.

9. The method of claim 1, further comprising outputting a completed application form.

10. The method of claim 9, further comprising displaying the completed application form.

11. The method of claim 9, further comprising sending the completed application form over a network.

12. The method of claim 1, further comprising receiving an input from a user.

13. The method of claim 1, wherein the pre-defined format is EXtensible Markup Language (XML).

14. The method of claim 1, wherein the received information includes at least one of text data and image data.

15. The method of claim 1 further comprising printing the received information at respective coordinates of the fields in the application form.

16. A system for adding information to application forms, the system comprising:
a unit configured to:
receive an unfilled application form, the unfilled application form includes various fields; and
a processor configured to:
identify a type of the application form, the fields, and other related information of the application form;
detect a mobile device located within a predetermined range of the system;
receive information from the mobile device in a pre-defined format;
match the received information against the fields included in the unfilled application form; and
overlay the received information on the unfilled application form, based on the matching performed.

17. The system of claim 16, further comprising an output module configured to output a completed application form.

18. The system of claim 16, further comprising a display configured to display a completed application form.

19. The system of claim 16, further comprising an input module configured to receive an input from a user.

20. The system of claim 16, further comprising a communication module configured to establish a communication channel between the system and the mobile device.

21. The system of claim 16, further comprising a network module configured to send a completed application form over a network.

22. A method for automatically filling-out one or more application forms, comprising:
receiving an application form, the form includes a plurality of fields;
identifying information related to the application form;
initiating a form filling application on a first device having a processor;
detecting a second device including a storage medium, in an area proximate the first device;
receiving information from the second device in a pre-defined format;
identifying one or more fields of the plurality of fields in the application form, corresponding to the received information;
checking for at least one of completeness and correctness of the received information;
placing the received information at corresponding coordinates of the identified fields; and
outputting a filled out application form.

23. The method of claim 22, further comprising converting the received information from the pre-defined format to a second format.

24. The method of claim 22, wherein identifying the one or more fields includes matching the received information with the fields included in the application form.

25. The method of claim 22, further comprising capturing one or more parameters related to the application form.

26. The method of claim 22, wherein the application form is partially-filled.

27. The method of claim 26, further comprising scanning the partially-filled application form.

28. The method of claim 22, wherein the application form is completely unfilled.

29. The method of claim 22, wherein the first device is a multi-function device.

30. The method of claim 22, wherein the second device is a mobile device.

31. An automation system interacting with a mobile device, for automatically filling-out application forms, the automation system comprising:
a unit configured to:
receive an unfilled application form, the form includes various fields; and
a processing module configured to:
identify information related to the unfilled application form;
initiate a form filling application on the automation system;
detect a mobile device in a location proximate to the automation system;
receive user information from the mobile device;
identify one or more fields corresponding to the received user information;
check for at least one of completeness or correctness of the received information;
overlay the received user information on the identified fields; and
output a completed application form.

32. A method, comprising:
receiving an input from a user;
identifying an application form, based on the input, wherein the application form includes various fields;
initiating a form filling application on a first device;
detecting a second device, in an area proximate the first device;
receiving information from the second device in a pre-defined format;
identifying one or more fields corresponding to the received information;
checking for at least one of completeness and correctness of the received information;
generating an image of the received information;
placing the image at corresponding coordinates of the identified fields; and
outputting a filled out application form.
